(19) United States
(12) Patent Application Publication
(10) Pub. No.: US 2021/0164613 A1
(43) Pub. Date: Jun. 3, 2021

(54) CONTROL METHOD FOR HANDHELD GIMBAL, HANDHELD GIMBAL, AND IMAGE ACQUISITION DEVICE

(71) Applicant: SZ DJI TECHNOLOGY CO., LTD., Shenzhen (CN)

(72) Inventors: Wenjun WANG, Shenzhen (CN); Qinghe FAN, Shenzhen (CN)

(21) Appl. No.: 17/174,572

(22) Filed: Feb. 12, 2021

Related U.S. Application Data
(63) Continuation of application No. PCT/CN2018/103551, filed on Aug. 31, 2018.

(51) Int. Cl. F16M 13/04; H04N 5/232

(52) U.S. Cl. CPC F16M 13/04; H04N 5/2251; H04N 5/2328

(57) ABSTRACT

A handheld gimbal includes a handle, a stabilization assembly mounted at the handle and configured to carry a load, an inertial measurement unit configured to obtain an actual attitude of the load and an actual attitude of the handle, and a microcontroller connected to the inertial measurement unit and configured to determine an operation mode of the handheld gimbal and control rotation of the stabilization assembly according to the operation mode of the handheld gimbal, the actual attitude of the load, and the actual attitude, to cause the load to rotate to a desired attitude.

### CROSS-REFERENCE TO RELATED APPLICATION

This application is a continuation of International Application No. PCT/CN2018/103551, filed Aug. 31, 2018, the entire content of which is incorporated herein by reference.

### TECHNICAL FIELD

The present disclosure relates to the field of photography and, in particularly, to a control method for handheld gimbal, a handheld gimbal, and an image acquisition device.

### BACKGROUND

Nowadays, a handheld gimbal to facilitate user holding or fixed use in different scenes typically includes normal shooting mode, flashlight mode, upside-down shooting mode, etc. However, existing handheld gimbal shooting modes are used under normal conditions, in which the user typically shoots in a primary direction using the gimbal. When the user uses the handheld gimbal underwater, the body of the user is not perpendicular to the water surface in most of the time, and sometimes is even about parallel to the water surface. At this time, if the user still uses the usual gimbal shooting mode underwater, such as the flashlight mode, in which the roll axis is fixed and the pitch and yaw axes follow, the hand joint of the user will feel obvious discomfort when the user shoots the front, left, or right. And it is not conducive to the user to observe the display screen.

### SUMMARY

In accordance with the disclosure, there is provided a handheld gimbal including a handle, a stabilization assembly mounted at the handle and configured to carry a load, an inertial measurement unit configured to obtain an actual attitude of the load and an actual attitude of the handle, and a microcontroller connected to the inertial measurement unit and configured to determine an operation mode of the handheld gimbal and control rotation of the stabilization assembly according to the operation mode of the handheld gimbal, the actual attitude of the load, and the actual attitude, to cause the load to rotate to a desired attitude.

Also in accordance with the disclosure, there is a provided a control method of a handheld gimbal including determining an operation mode of a handheld gimbal. The handheld gimbal includes a handle and a stabilization assembly mounted at the handle, and the stabilization assembly is configured to carry a load. The method further includes obtaining an actual attitude of the load and an actual attitude of the handle, and controlling rotation of the stabilization assembly according to the operation mode of the handheld gimbal, the actual attitude of the load, and the actual attitude of the handle, to cause the load to rotate to a desired attitude.

### BRIEF DESCRIPTION OF THE DRAWINGS

FIG. 1 is a schematic structural diagram of an image acquisition device consistent with embodiments of the disclosure.

FIG. 2 to FIG. 12 are the schematic flow charts of a control method of a handheld gimbal consistent with embodiments of the disclosure.

### DETAILED DESCRIPTION OF THE EMBODIMENTS

The embodiments of the present disclosure are described in detail below. Examples of the embodiments are shown in the drawings, where the same numbers indicate the same or similar components or components with the same or similar functions. The embodiments described below with reference to the drawings are exemplary and are only used to explain the present disclosure, and should not be understood as a limitation to the present disclosure.

The terms “first” and “second” are used for descriptive purposes only and should not be understood as indicating or implying relative importance or implicitly indicating the number of technical features indicated. Thus, a feature described with “first” or “second” may include one or more of such feature explicitly or implicitly. In the description of the present disclosure, “multiple” or “plurality of” means two or more, unless otherwise specified.

In the description of the present disclosure, unless otherwise defined and specified, the term “mount,” “connect” and “communication” should be understood broadly. For example, a connection may be a fixed connection or a detachable connection, or a whole; it may be a mechanical connection, or may be an electrical connection, or may be a communication with each other; it may be a direct connection, or may be an indirect connection via an intermediate medium, or may be an internal connection of two components or the interaction between two components. For persons of ordinary skill in the art, the specific meaning of the above terms in the present disclosure can be understood according to the specific circumstances.

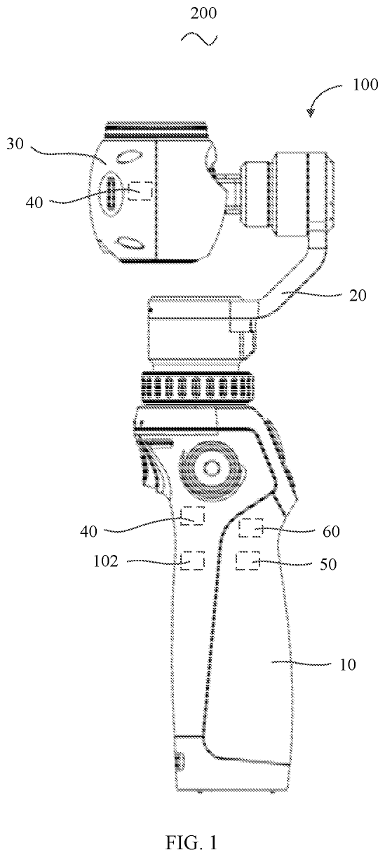

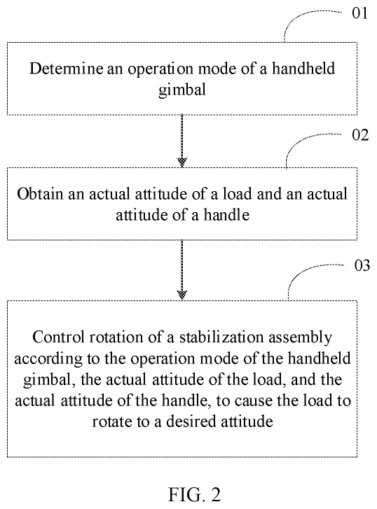

FIG. 1 is a schematic structural diagram of an example handheld gimbal 100. As shown in FIG. 1, the handheld gimbal 100 includes a handle 10 and a stabilization assembly 20 mounted at the handle 10. The stabilization assembly 20 is configured to carry a load 30. FIG. 2 is a schematic flow chart of an example control method of the handheld gimbal 100 consistent with the disclosure. As shown in FIG. 2, the control method includes the following processes.

At 01, an operation mode of the handheld gimbal 100 is determined.

At 02, an actual attitude of the load 30 and an actual attitude of the handle 10 are obtained.

At 03, rotation of a stabilization assembly 20 is controlled according to the operation mode of the handheld gimbal 100, the actual attitude of the load 30, and the actual attitude of the handle 10, to cause the load 30 to rotate to a desired attitude.

Process 01 can be performed before process 02, or process 01 can be performed after process 02, or process 01 and process 02 can be performed simultaneously. The handheld gimbal 100 also includes an inertial measurement unit 40 and a microcontroller 50. The inertial measurement unit 40 can be used to perform process 02. That is, the inertial measurement unit 40 can be used to obtain the actual attitude of the load 30 and the actual attitude of the handle 10. The microcontroller 50 is connected to the inertial measurement unit 40 and can be used to perform processes 01 and 03. That is, the microcontroller 40 can be used to determine the operation mode of the handheld gimbal 100, and to control the rotation of the stabilization assembly 20 according to the operation mode of the handheld gimbal 100, the actual attitude of the load 30, and the actual attitude of the handle 10, to cause the load 30 to rotate to the desired attitude.

In some embodiments, two inertial measurement units 40 can be provided. One of the inertial measurement units 40 can be provided at a rotation axis frame (such as a pitch axis frame, not shown) configured to carry the load 30 and can be used to measure the actual attitude of the load 30. The other inertial measurement unit 40 can be provided at the handle 10 and used to measure the actual attitude of the handle 10. In some other embodiments, only one inertial measurement unit 40 can be provided. The inertial measurement unit 40 can be provided at the rotation axis frame carrying the load 30, and can be used to detect the actual attitude of the rotation axis frame (i.e., the actual attitude of the load 30). The actual attitude of the handle 10 can then be calculated according to the actual attitude of the load 30 and motor joint angle data. The stabilization assembly 20 can be a single-axis gimbal assembly, a two-axis gimbal assembly, or a three-axis gimbal assembly. When the stabilization assembly 20 is a three-axis gimbal assembly, the stabilization assembly 20 can include a yaw axis assembly, a roll axis assembly, and a pitch axis assembly. The load 30 can be a camera. When the user operates (including rotates and moves) the handle 10, the stabilization assembly 20 follows the handle 10 under the operation mode of the handheld gimbal 100 to move in a certain pattern.

The handheld gimbal 100 can include a variety of operation modes, such as a vertical shooting mode, an underwater mode, a flashlight mode, etc. The operation mode of the handheld gimbal 100 can be selected via a mode selection button (not shown) provided at the handheld gimbal 100. The mode selection button can be connected to the microcontroller 50, and the microcontroller 50 can obtain the mode selected by the user via the mode selection button and determine the operation mode of the handheld gimbal 100.

The desired attitude of the load 30 can be determined by the operation mode of the handheld gimbal 100. In some embodiments, an operation mode of the handheld gimbal 100 corresponds to a desired attitude of the load 30. After the microcontroller 50 determines the operation mode of the handheld gimbal 100, the desired attitude of the load 30 can be determined according to the operation mode of the handheld gimbal 100 and the actual attitude of handle 10. For example, assume the operation mode of the handheld gimbal 100 is the underwater mode. In one situation, the desired attitude of the load 30 is maintained to be basically consistent with the actual attitude of the handle 10. That is, the load 30 follows the handle 10. Maintaining the desired attitude of the load 30 to be basically consistent with the actual attitude of the handle 10 can include: (1) an angle difference between the desired attitude of the load 30 and the actual attitude of the handle 10 is 0°; or (2) the angle difference between the desired attitude of the load 30 and the actual attitude of the handle 10 is in a preset range, such as equaling or less than 5°, equaling or less than 3°, equaling or less than 2°, etc. In another situation, the desired attitude of the load 30 corresponds to the actual attitude of the handle 10. The desired attitude of the load 30 corresponding to the actual attitude of the handle 10 can mean that the angle difference between the desired attitude of the load 30 and the actual attitude of the handle 10 is a preset angle. The preset angle can be 0°, 5°, 10°, 20°, 30°, 60°, 90°, etc.

The microcontroller 50 can obtain the actual attitude of the load 30 and the actual attitude of the handle 10 through the inertial measurement unit 40 and control the rotation of the stabilization assembly 20 according to the operation mode of the handheld gimbal 100, the actual attitude of the load 30, and the actual attitude of the handle 10, to cause the load 30 to rotate to the desired attitude. The rotation of the stabilization assembly 20 can be understood as the rotation of at least one axis in the stabilization assembly 20.

In the handheld gimbal 100 and the control method consistent with the disclosure, the rotation of the stabilization assembly 20 is controlled according to the operation mode of the handheld gimbal 100, the actual attitude of the load 30, and the actual attitude of the handle 10, to cause the load 30 to rotate to the desired attitude. As such, when the user operates the handle 10, the load 30 can rotate to the desired attitude for the user to use the load 30. In particular, when the handheld gimbal 100 is used underwater in a follow-up manner, the hand joints of the user are not uncomfortable when the user shoots front, left, or right, and it is convenient for the user to view the display screen of the load 30.

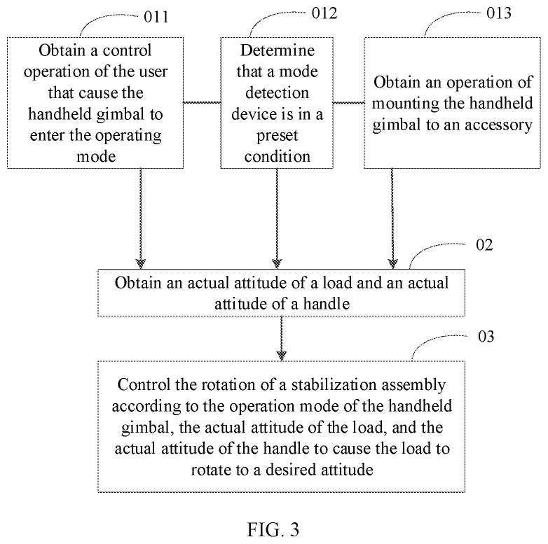

As shown in FIG. 1 and FIG. 3, in some embodiments, determining the operation mode of the handheld gimbal 100 (process 01) includes at least one of obtaining a control operation of the user that causes the handheld gimbal 100 to enter the operation mode (process 011), determining that a mode detection device 60 is in a preset condition (process 012), or obtaining an operation of mounting the handheld gimbal 100 to a specific accessory (process 013).

In some embodiments, the handheld gimbal 100 includes a control member such as the mode selection button, a knob, or a touch screen, the user can select the operation mode of the handheld gimbal 100 via the control member. In these embodiments, the microcontroller 50 can obtain the control operation of, e.g., the mode selection button, by the user and determine the operation mode of the handheld gimbal 100. In some other embodiments, the user can select the operation mode of the handheld gimbal 100 by a control operation on an external device, such as a remote controller, a mobile phone, or a tablet, that is connected to the handheld gimbal 100, and the microcontroller 50 can obtain the control operation of the mode selection by the external device and determine the operation mode of the handheld gimbal 100. For example, when a user operates on a button of the handheld gimbal 100 or an application on a mobile phone connected to the handheld gimbal 100 to select the underwater mode, the handheld gimbal 100 enters the underwater mode in response to that operation.

In some embodiments, the handheld gimbal 100 includes the mode detection device 60, and the microcontroller 50 can determine the operation mode of the handheld gimbal 100 according to whether the mode detection device 60 reaches the preset condition. The mode detection device 60 can include at least one of a detection structure, a detection reagent, or a detection sensor.

The detection structure can include a pressure detection structure. When the detection structure includes a pressure detection structure, the preset condition is to detect whether the pressure on the structure reaches a preset pressure value. For example, because the pressure on an object in the water is positively related to a depth of the object in the water, the pressure on the pressure detection structure is small when the handheld gimbal 100 is just put in the water. As the depth of the pressure detection structure in the water gradually increases, the pressure on the pressure detection structure gradually increases. When the pressure on the pressure detection structure excesses the preset pressure value, the microcontroller 50 can determine that the handheld gimbal 100 is underwater according to the pressure value detected by the pressure detection structure. Then the handheld gimbal 100 can be set to the underwater mode.

The detection reagent can include a humidity detection reagent, a water detection reagent, and/or a water pressure detection reagent. When the detection reagent is a humidity detection reagent and detects that the humidity value of the environment in which the handheld gimbal 100 is located exceeds a preset humidity value, the microcontroller 50 can determine that the handheld gimbal 100 is underwater according to the humidity value detected by the detection reagent. When the detection reagent is a water detection reagent and detects that the handheld gimbal 100 is in a water environment, for example, the handheld gimbal 100 includes one or more water detection reagent points and water is detected at each point, the microcontroller 50 can determine that the handheld gimbal 100 is underwater according to the detection results of the water detection reagent. When the detection reagent is a water pressure detection reagent and detects that the water pressure value of the environment in which the handheld gimbal 100 is located exceeds a preset water pressure value, the microcontroller 50 can determine that the handheld gimbal 100 is underwater according to the water pressure value detected by the detection reagent. When the detection reagent includes both water pressure detection reagent and humidity detection reagent, the microcontroller 50 can determine that the handheld gimbal 100 is underwater when both the water pressure value of the environment in which the handheld gimbal 100 is located exceeds the preset water pressure value and the humidity value detected exceeds the preset humidity value.

The detection sensor can include a water pressure sensor and the preset condition includes the water pressure detected by the sensor having reached a preset pressure value. When the water pressure sensor detects that the water pressure in the environment in which the handheld gimbal 100 is located increases to the preset pressure value, the microcontroller 50 can determine that the handheld gimbal 100 is underwater according to the pressure value detected by the detection sensor, and then the handheld gimbal 100 can be controlled to enter the underwater mode.

In some embodiments, the handheld gimbal 100 is mounted at a specific accessory. The handheld gimbal 100 can include a plurality of coupling members configured to be connected to the specific accessory. The coupling members are each equipped with a sensor (e.g., a proximity sensor). The accessory can include a plurality of connection members configured to be connected with the coupling members of the handheld gimbal 100. When the connection members of the accessory are connected to the coupling members of the handheld gimbal 100, the sensors receive operation signals. According to the operation signals, the microcontroller 50 can determine that the handheld gimbal 100 is mounted at a specific accessory and determine the operation mode of the handheld gimbal 100. The specific accessory can include a waterproof case. When the handheld gimbal 100 is mounted to that specific accessory, the microcontroller 50 can determine that the handheld gimbal 100 is underwater.

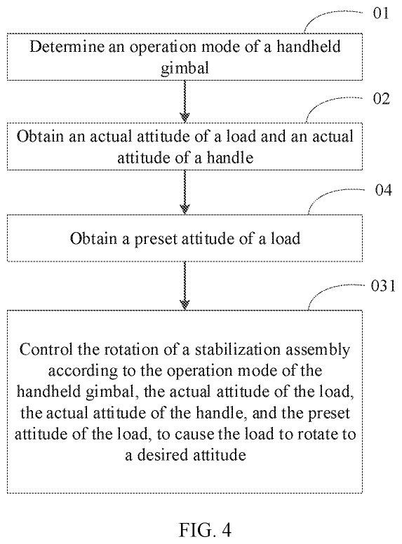

As shown in FIG. 1 and FIG. 4, in some embodiments, the control method for the handheld gimbal 100 also includes obtaining the preset attitude of the load 30 (process 04).

Controlling the rotation of the stabilization assembly 20 according to the operation mode of the handheld gimbal 100, the actual attitude of the load 30, and the actual attitude of the handle 10 (process 03) includes controlling the rotation of the stabilization assembly 20 to cause the load 30 to rotate to the desired attitude according to the operation mode of the handheld gimbal 100, the actual attitude of the load 30, the actual attitude of the handle 10, and the preset attitude of the load 30 (process 031).

The microcontroller 50 can also be used to perform process 04 and process 031. That is, the microcontroller 50 can also be used to obtain a preset attitude of the load 30, and to control the rotation of the stabilization assembly 20 according to the operation mode of the handheld gimbal 100, the actual attitude of the load 30, the actual attitude of the handle 10, and the preset attitude of the load 30.

The preset attitude of the load 30 is an attitude of the load 30 preset by the handheld gimbal 100. The preset attitude of the load 30 can be different from the desired attitude of the load 30. In some embodiments, there can be a preset attitude difference between the preset attitude of the load 30 and the desired attitude of the load 30, and the actual attitude of load the 30 is the preset attitude of load 30 when the attitude difference between the actual attitude of the load 30 and the desired attitude of the load 30 is the preset attitude difference.

When the actual attitude of the load 30 is between the preset attitude of the load 30 and the actual attitude of the handle 10 (or the desired attitude of the load 30), the microcontroller 50 can control the stabilization assembly 20 to rotate towards the actual attitude of the handle 10 (or the desired attitude of the load 30) at a first rotation speed to the desired attitude of the load 30. For example, if the preset attitude is 45°, the actual attitude of the load 30 is 35°, the actual attitude of the handle 10 and the desired attitude of the load 30 are both 0°, the microcontroller 50 can control the stabilization assembly 20 to rotate to the desired attitude (0°) at a rotation speed of 5 rad/s.

When the preset attitude of load 30 is between the actual attitude of the load 30 and the actual attitude of the handle 10 (or the desired attitude of the load 30), the microcontroller 50 can control the stabilization assembly 20 to rotate towards the actual attitude of the handle 10 (or the desired attitude of the load 30) at a second rotation speed to the desired attitude of the load 30. For example, if the preset attitude is 45°, the actual attitude of the load 30 is 60°, the actual attitude of the handle 10 and the desired attitude of the load 30 are both 0°, the microcontroller 50 can control stabilization assembly 20 to rotate to the desired attitude (0°) at a rotation speed of 10 rad/s.

When the preset attitude of the load 30 is between the actual attitude of load 30 and the actual attitude of the handle 10 (or the desired attitude of the load 30), the microcontroller 50 can control the stabilization assembly 20 to rotate towards the actual attitude of the handle 10 (or the desired attitude of the load 30) at the second rotation speed to the preset attitude of the load 30, and then control the stabilization assembly 20 to rotate towards the actual attitude of the handle 10 (or the desired attitude of the load 30) at the first rotation speed to the desired attitude of the load 30. For example, if the preset attitude is 45°, the actual attitude of the load 30 is 60°, the actual attitude of the handle 10 and the desired attitude of the load 30 are both 0°, the microcontroller 50 can control the stabilization assembly 20 to rotate to 45° at a rotation speed of 10 rad/s, and then control the stabilization assembly 20 to rotate from 45° to the desired attitude (0°) at a rotation speed of 5 rad/s.

In some embodiments, both the first rotation speed and the second rotation speed can be average speed. When the stabilization assembly 20 rotates at the first rotation speed, the load 30 mounted at the stabilization assembly 20 can work properly. For example, assume the load 30 is a camera, when the stabilization assembly 20 rotates at the first rotation speed, the image captured by the camera can meet the needs of the user; when the difference between the actual attitude of the load 30 and the actual attitude of the handle 10 is significant (i.e., the preset attitude of the load 30 is between the actual attitude of the load 30 and the actual attitude of the handle 10), the stabilization assembly 20 rotates at the second rotation speed, which can avoid further increasing the difference between the actual attitude of the load 30 and the actual attitude of the handle 10.

In the control method of the handheld gimbal 100 consistent with the disclosure, the rotation of the stabilization assembly 20 can be controlled according to the operation mode of the handheld gimbal 100, the actual attitude of the load 30, the actual attitude of the handle 10, and the preset attitude of the load 30, to cause the load 30 to rotate to the desired attitude, which not only can increase the operation range of the load 30, but also can avoid significant difference between the actual attitude of the load 30 and the desired attitude of the load 30.

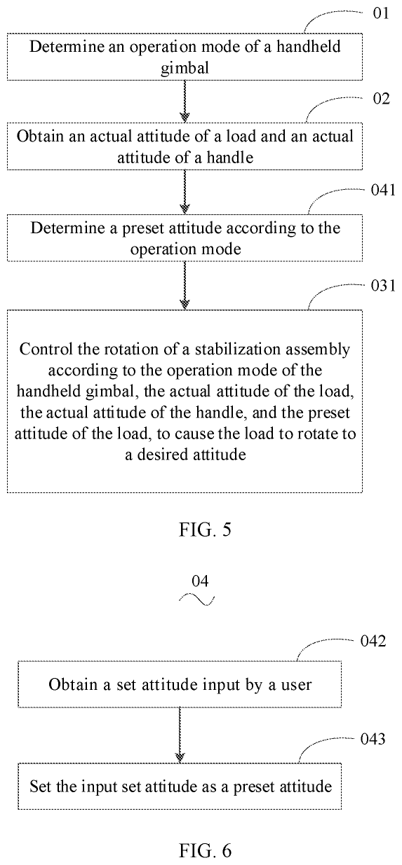

As shown in FIG. 1 and FIG. 5, in some embodiments, obtaining the preset attitude of the load 30 (process 04) includes determining the preset attitude according to the operation mode (process 041).

The microcontroller 50 can also be used to perform process 041, i.e., the microcontroller 50 can also be used to determine the preset attitude according to the operation mode.

In some embodiments, there is a one-to-one correspondence relationship between the operation mode of the handheld gimbal 100 and the preset attitude of the load 30, and the microcontroller 50 can determine the preset attitude of the load 30 according to the operation mode of the handheld gimbal 100. For example, if the operation mode of the handheld gimbal 100 is the underwater mode, the angle (or rotation angle) between the preset attitude of the load 30 and the desired attitude of the load 30 is 45°.

As shown in FIG. 1, FIG. 4, and FIG. 6, in some embodiments, obtaining the preset attitude of the load 30 (process 04) includes obtaining a set attitude input by the user (process 042), and setting the set attitude as the preset attitude (043).

In some embodiments, as shown in FIG. 1, the handheld gimbal 100 also includes an input device 102. The input device 102 can receive input by the user and determine the setting of the attitude according to the input. The input device 102 can include a touch display screen or an input button, and the input device 102 can be mounted at the handle 10. The microcontroller 50 can be connected to the input device 102, and the microcontroller 50 can obtain the set attitude via the input device 102, and can determine the preset attitude according to the set attitude. The input by the user can be a value corresponding to the preset attitude. For example, when the preset attitude of the load 30 desired by the user is 45°, the user can enter the number “45,” then the input device 102 can determine the set attitude as 45° according to the number “45,” and the microcontroller 50 can obtain the set attitude via the input device 102 and determine the preset attitude as 45°. In some embodiments, the input by the user can be a preset setting mode. The input device 102 can save angles corresponding to preset set modes (in this scenario, the input device 102 can include a storage device for data storage). The input device 102 can determine the preset attitude according to the preset set mode selected by the user. For example, the correspondence relationship between set modes and attitudes stored by the input device 102 includes “Set mode 1” corresponding to “45°.” When the preset attitude of the load 30 desired by the user is 45°, the user can input “Set mode 1,” and the input device 102 can determine the set attitude as 45° according to the correspondence relationship between set modes and attitudes. The microcontroller 50 can obtain the set attitude via the input device 102 and determine the preset attitude as 45°. In some other embodiments, the user can also input a set attitude via a remote controller connected to the microcontroller 50, and the microcontroller 50 can obtain the set attitude via the remote controller.

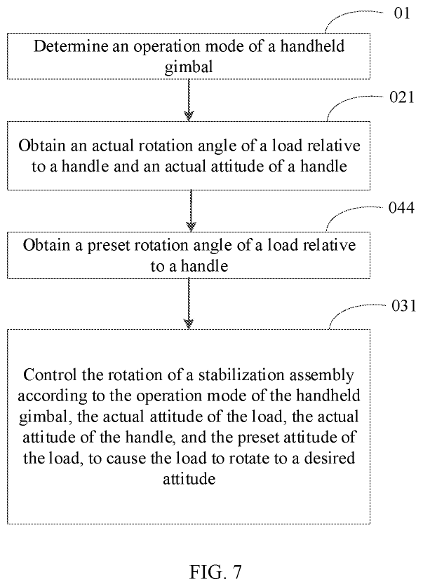

As shown in FIG. 1 and FIG. 7, in some embodiments, obtaining the actual attitude of the load 30 and the actual attitude of the handle (process 02) includes obtaining the actual rotation angle of the load 30 relative to the handle 10 and the actual attitude of the handle 10 (process 021).

Obtaining the preset attitude of the load 30 (process 04) includes obtaining the preset rotation angle of the load 30 relative to the handle 10 (process 044).

In some embodiments, obtaining the actual attitude of the load 30 includes obtaining the actual rotation angle of the load 30 relative to the handle 10. The inertial measurement unit 40 can also be used to obtain the actual rotation angle of the load 30 relative to the handle 10.

The microcontroller 50 can also be used to obtain the preset rotation angle of the load 30 relative to the handle 10.

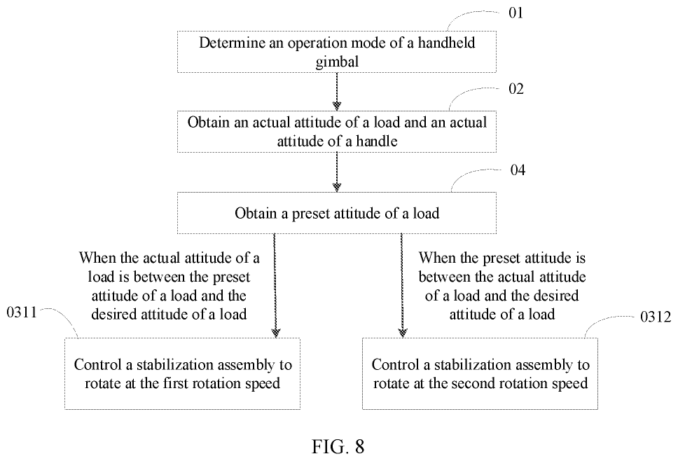

As shown in FIG. 1 and FIG. 8, in some embodiments, controlling the rotation of the stabilization assembly 20 according to the operation mode of the handheld gimbal 100, the actual attitude of the load 30, the actual attitude of the handle 10, and the preset attitude of the load 30 (process 031) includes controlling the stabilization assembly 20 to rotate at a first rotation speed when the actual attitude of the load 30 is between the preset attitude of the load 30 and the desired attitude of the load 30 (process 0311), or controlling the stabilization assembly 20 rotate at a second rotation speed greater than the first rotation speed when the preset attitude of the load 30 is between the actual attitude of the load 30 and the desired attitude of the load 30 (process 0312).

The microcontroller 50 can also be used to perform process 0311 and process 0312. That is, the microcontroller 50 can also be used to control the stabilization assembly 20 to rotate at the first rotation speed when the actual attitude of the load 30 is between the preset attitude of the load 30 and the desired attitude of the load 30, and to rotate at the second rotation speed when the preset attitude of the load 30 is between the actual attitude of the load 30 and the desired attitude of the load 30.

In some embodiments, both the first rotation speed and the second rotation speed can be average speed.

The microcontroller 50 can control the stabilization assembly 20 to rotate to the desired attitude of the load 30 at the first rotation speed when the actual attitude of the load 30 is between the preset attitude of the load 30 and the desired attitude of the load 30. For example, if the preset attitude is 45°, the actual attitude of load 30 is 30°, and the desired attitude of load 30 is 0°, the microcontroller 50 then can control the stabilization assembly 20 to rotate from 30° to the desired attitude (0°) at a rotation speed of 5 rad/s.

The microcontroller 50 can control the stabilization assembly 20 to rotate to the preset attitude of the load 30 at the second rotation speed, and then control the stabilization assembly 20 to rotate to the desired attitude of the load 30 at the first rotation speed when the preset attitude of the load 30 is between the actual attitude of the load 30 and the desired attitude of the load 30. For example, if the preset attitude is 45°, the actual attitude of the load 30 is 60°, and the desired attitude of the load 30 is 0°, the microcontroller 50 can control the stabilization assembly 20 to rotate to 45° at a rotation speed of 10 rad/s, and then control the stabilization assembly 20 to rotate from 45° to the desired attitude (0°) at a rotation speed of 5 rad/s.

In some embodiments, the load 30 mounted at the stabilization assembly 20 can work properly when the stabilization assembly 20 rotates at the first rotation speed. For example, assume the load 30 is a camera, the image captured by the camera can meet needs of the user when the stabilization assembly 20 rotates at the first rotation speed. When the difference between the actual attitude of the load 30 and the desired attitude of the load 30 is relatively large (i.e., the preset attitude of the load 30 is between the actual attitude of the load 30 and the desired attitude of the load 30), the stabilization assembly 20 rotating at the second rotation speed can prevent the difference between the actual attitude of the load 30 and the desired attitude of the load 30 from further increasing.

In the control method of the handheld gimbal 100 consistent with the disclosure, the rotation of the stabilization assembly 20 can be controlled according to the operation mode of the handheld gimbal 100, the actual attitude of the load 30, the actual attitude of the handle 10, and the preset attitude of the load 30, to cause the load 30 to rotate to the desired attitude, which not only can increase the operation range of the load 30, but also can prevent the difference between the actual attitude of the load 30 and the desired attitude of the load 30 from being too large.

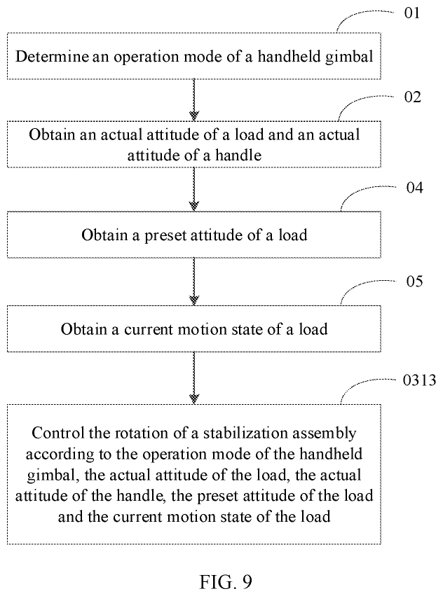

As shown in FIG. 1 and FIG. 9, in some embodiments, the control method for the handheld gimbal 100 also includes obtaining a current motion state of the load 30 (process 05).

Controlling the rotation of the stabilization assembly 20 according to the operation mode of the handheld gimbal 100, the actual attitude of the load 30, the actual attitude of the handle 10, and the preset attitude of the load 30 (process 031) includes controlling the rotation of the stabilization assembly 20 according to the operation mode of the handheld gimbal 100, the actual attitude of the load 30, the actual attitude of the handle 10, the preset attitude of the load 30, and the current motion state of the load 30 (process 0313).

The microcontroller 50 can also be used to perform process 0313. That is, the microcontroller 50 can also be used to control the rotation of the stabilization assembly 20 according to the operation mode of the handheld gimbal 100, the actual attitude of the load 30, the actual attitude of the handle 10, the preset attitude of the load 30, and the current motion state of the load 30.

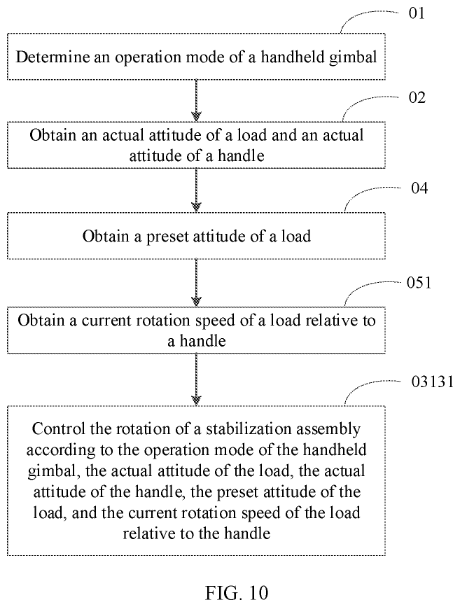

As shown in FIG. 10, in some embodiments, the current motion state can include a current rotation speed of the load 30 relative to the handle 10. Obtaining the current motion state of the load 30 (process 05) includes obtaining the current rotation speed of the load 30 relative to the handle 10 (process 051). The inertial measurement unit 40 can be used to obtain the current rotation speed of the load 30 relative to the handle 10. Controlling the rotation of the stabilization assembly 20 according to the operation mode of the handheld gimbal 100, the actual attitude of the load 30, the actual attitude of the handle 10, the preset attitude of the load 30, and the current motion state of the load 30 (process 0313) includes controlling the rotation of the stabilization assembly 20 according to the operation mode of the handheld gimbal 100, the actual attitude of the load 30, the actual attitude of the handle 10, the preset attitude of the load 30, and the current rotation speed of the load 30 (process 03131). The microcontroller 50 can also be used to perform process 03131. That is, the microcontroller 50 can also be used to control the rotation of the stabilization assembly 20 according to the operation mode of the handheld gimbal 100, the actual attitude of the load 30, the actual attitude of the handle 10, the preset attitude of the load 30, and the current rotation speed of the load 30.

In some embodiments, when the direction of the current rotation speed of the load 30 is a direction away from the desired attitude of the load 30, the microcontroller 50 can first control the stabilization assembly 20 to rotate away from the desired attitude of the load 30 at a gradually decreasing rotation speed so that the rotation speed of the load 30 drops to 0, and then control the stabilization assembly 20 to rotate towards the desired attitude of the load 30 until the load 30 rotates to the desired attitude.

When the direction of the current rotation speed of the load 30 is a direction towards the desired attitude of the load 30, the microcontroller 50 can control the stabilization assembly 20 to rotate towards the desired attitude of the load 30 until the load 30 reaches the desired attitude.

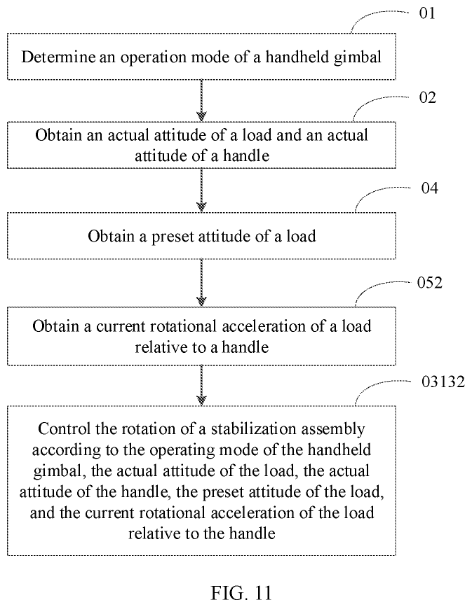

As shown in FIG. 1 and FIG. 11, in some embodiments, the current motion state can include a current rotational acceleration of the load 30 relative to the handle 10. Obtaining the current motion state of the load 30 (process 05) includes obtaining the current rotational acceleration of the load 30 relative to the handle 10 (process 052). The inertial measurement unit 40 can be used to obtain the current rotational acceleration of the load 30 relative to the handle 10. Controlling the rotation of the stabilization assembly 20 according to the operation mode of the handheld gimbal 100, the actual attitude of the load 30, the actual attitude of the handle 10, the preset attitude of the load 30, and the current motion state of the load 30 (process 0313) includes controlling the rotation of the stabilization assembly 20 according to the operation mode of the handheld gimbal 100, the actual attitude of the load 30, the actual attitude of the handle 10, the preset attitude of the load 30, and the current rotational acceleration of the load 30 (process 03132). The microcontroller 50 can also be used to perform process 03132. That is, the microcontroller 50 can also be used to control the rotation of the stabilization assembly 20 according to the operation mode of the handheld gimbal 100, the actual attitude of the load 30, the actual attitude of the handle 10, the preset attitude of the load 30, and the current rotational acceleration of the load 30.

In some embodiments, when the direction of the current rotational acceleration of the load 30 is away from the desired attitude of the load 30, the microcontroller 50 can first control the direction of the rotational acceleration of the stabilization assembly 20 to be toward the desired attitude of the load 30, and then control the direction of the rotational acceleration of the stabilization assembly 20 to be away from the desired attitude when the actual attitude of load 30 is close to the desired attitude (e.g., when the angle between the load 30 and the desired attitude is less than 5°), to cause the load 30 to stop at the desired attitude when the load 30 reaches the desired attitude.

When the direction of the current rotational acceleration of the load 30 is towards the desired attitude of the load 30, the microcontroller 50 can first control the direction of the rotational acceleration of the stabilization assembly 20 to maintain at the direction towards the desired attitude of the load 30, and then control the direction of the rotational acceleration of the stabilization assembly 20 to be away from the desired attitude when the actual attitude of the load 30 is close to the desired attitude (e.g., when the angle between the load 30 and the desired attitude is less than 5°), to cause the load 30 to stop at the desired attitude when the load 30 reaches the desired attitude.

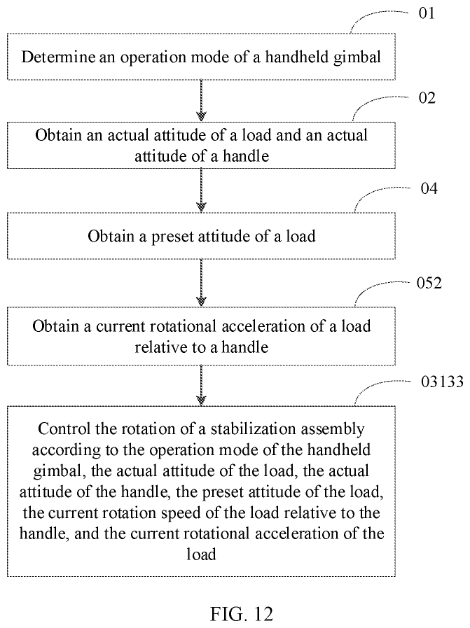

As shown in FIG. 1 and FIG. 12, in some embodiments, the current motion state can include the current rotation speed and the current rotational acceleration of the load 30 relative to the handle 10. Obtaining the current motion state of the load 30 (process 05) includes obtaining the current rotation speed of the load 30 relative to the handle 10 and the current rotational acceleration (process 053). The inertial measurement unit 40 can be used to obtain the current rotation speed and the current rotational acceleration of the load 30 relative to the handle 10. Controlling the rotation of the stabilization assembly 20 according to the operation mode of the handheld gimbal 100, the actual attitude of the load 30, the actual attitude of the handle 10, the preset attitude of the load 30, and the current motion state of the load 30 (process 0313) includes controlling the rotation of the stabilization assembly 20 according to the operation mode of the handheld gimbal 100, the actual attitude of the load 30, the actual attitude of the handle 10, the preset attitude of the load 30, and the current rotation speed and the current rotational acceleration of the load 30 (process 03133). The microcontroller 50 can also be used to perform process 03133. That is, the microcontroller 50 can also be used to control the rotation of the stabilization assembly 20 according to the operation mode of the handheld gimbal 100, the actual attitude of the load 30, the actual attitude of the handle 10, the preset attitude of the load 30, and the current rotation speed and the current rotational acceleration of the load 30.

In some embodiments, when both the direction of the current rotation speed and the direction of the current rotational acceleration of the load 30 are away from the desired attitude of the load 30, the microcontroller 50 first can control the direction of the current rotational acceleration of the stabilization assembly 20 to be toward the desired attitude of the load 30, to cause the rotation speed of the stabilization assembly 20 to gradually decrease until the rotation speed drops to 0. The microcontroller 50 then can control the current rotational acceleration of the stabilization assembly 20 to maintain at the direction towards the desired attitude of the load 30, to cause the rotation speed of the stabilization assembly 20 to gradually increase in the direction towards the desired attitude of the load 30. When the load 30 is close to the desired attitude (e.g., when the angle between the load 30 and the desired attitude is less than 5°), the microcontroller 50 can control the direction of the rotational acceleration of the stabilization assembly 20 to be away from the desired attitude, to cause the load 30 to stop at the desired attitude when the load 30 reaches the desired attitude.

When both the direction of the current rotation speed of the load 30 and the direction of the current rotational acceleration are towards the desired attitude of the load 30, the microcontroller 50 can first control the direction of the current rotational acceleration of the stabilization assembly 20 to maintain at the direction towards the desired attitude of the load 30 (or makes the current acceleration drop to 0) to cause the stabilization assembly 20 to rotate towards the desired attitude of the load 30. When the load 30 is close to the desired attitude (e.g., when the angle between the load 30 and the desired attitude is less than 5°), the microcontroller 50 can control the direction of the rotational acceleration of the stabilization assembly 20 to be away from the desired attitude, to cause the load 30 to stop at the desired attitude when the load 30 reaches the desired attitude.

When the direction of the current rotation speed of the load 30 is towards the desired attitude of the load 30, and the direction of the current rotational acceleration is away from the desired attitude of the load 30, the microcontroller 50 can first control the direction of the current rotational acceleration of the stabilization assembly 20 to be towards the desired attitude of the load 30 (or makes the current acceleration drop to 0), to cause the stabilization assembly 20 rotate towards desired attitude of the load 30. When the load 30 is close to the desired attitude (e.g., when the angle between the load 30 and the desired attitude is less than 5°), the microcontroller 50 can control the direction of the rotational acceleration of the stabilization assembly 20 to be away from the desired attitude, to cause the load 30 to stop at the desired attitude when the load 30 reaches the desired attitude.

When the direction of the current rotation speed of the load 30 is away from the desired attitude of the load 30, and the direction of the current rotational acceleration is towards the desired attitude of the load 30, the microcontroller 50 can first control the direction of the current rotational acceleration of the stabilization assembly 20 to maintain at the direction towards the desired attitude of the load 30, to cause the rotation speed of the stabilization assembly 20 gradually decreases until the rotation speed drops to 0. The microcontroller 50 then can control the current rotational acceleration of the stabilization assembly 20 to maintain at the direction towards the desired attitude of the load 30, to cause the rotation speed of the stabilization assembly 20 gradually increases in the direction towards the desired attitude of the load 30. When the load 30 is close to the desired attitude (e.g., when the angle between the load 30 and the desired attitude is less than 5°), the microcontroller 50 can control the direction of the rotational acceleration of the stabilization assembly 20 to be away from the desired attitude, to cause the load 30 to stop at the desired attitude when the load 30 reaches the desired attitude.

In the handheld gimbal 100 and the control method consistent with the disclosure, the rotation of the stabilization assembly 20 can be controlled according to the current motion state, to reduce the vibration of the stabilization assembly 20 due to the sudden change in the rotation speed of the stabilization assembly 20.

As shown in FIG. 1, an image acquisition device 200 consistent with the disclosure includes the handheld gimbal 100 and the load 30 mounted at the handheld gimbal 100. The handheld gimbal 100 and the load 30 can be any example handheld gimbal and load described above. The load 30 can include an imaging device, such as a mobile phone or a camera.

The handheld gimbal 100 of the image acquisition device 200 consistent with the disclosure can control the rotation of the stabilization assembly 20 according to the operation mode of the handheld gimbal 100, the actual attitude of the load 30, and the actual attitude of the handle 10, to cause the load 30 to rotate to the desired attitude. As such, when the user operates the handle 10, the load 30 can rotate to the desired attitude for the user to use the load 30. In particular, when the handheld gimbal 100 is used underwater in a follow-up manner, the hand joints of the user are not uncomfortable when the user shoots front, left, or right, and it is convenient for the user to view the display screen of the load 30.

Although the above has shown and described the embodiments of the present disclosure, it is intended that the above embodiments be considered as examples only and not to limit the scope of the present disclosure. One of ordinary skill in the art can make changes, modifications, replacements, and transformation to the above embodiments within the scope of the present disclosure. The scope of the invention is defined by the claims and their equivalents.

What is claimed is:

1. A handheld gimbal comprising:
a handle;
a stabilization assembly mounted at the handle and configured to carry a load;
an inertial measurement unit configured to obtain an actual attitude of the load and an actual attitude of the handle; and
a microcontroller connected to the inertial measurement unit and configured to:
determine an operation mode of the handheld gimbal; and
control rotation of the stabilization assembly according to the operation mode of the handheld gimbal, the actual attitude of the load, and the actual attitude, to cause the load to rotate to a desired attitude.

2. The handheld gimbal of claim 1, wherein the microcontroller is further configured to perform at least one of:
obtaining a control operation of a user to set the handheld gimbal to the operation mode;
determining that a mode detection device is in a preset condition; or
obtaining an operation of mounting the handheld gimbal to an accessory.

3. The handheld gimbal of claim 2, wherein the mode detection device includes at least one of a detection structure, a detection reagent or a detection sensor.

4. The handheld gimbal of claim 2, wherein the accessory includes a waterproof case.

5. The handheld gimbal of claim 1, wherein the desired attitude is determined by the operation mode.

6. The handheld gimbal of claim 1, wherein the microcontroller is further configured to:
obtain a preset attitude of the load; and
control the rotation of the stabilization assembly according to the operation mode of the handheld gimbal, the actual attitude of the load, the actual attitude of the handle, and the preset attitude of the load.

7. The handheld gimbal of claim 6, wherein the microcontroller is further configured to:
determine the preset attitude of the load according to the operation mode of the handheld gimbal.

8. The handheld gimbal of claim 6, wherein the microcontroller is further configured to:
obtain a set attitude input by a user; and
determine the set attitude as the preset attitude.

9. The handheld gimbal of claim 6, wherein:
the inertial measurement unit is further configured to obtain an actual rotation angle of the load relative to the handle; and
the microcontroller is further configured to obtain a preset rotation angle of the load relative to the handle.

10. The handheld gimbal of claim 6, wherein the microcontroller is further configured to:
in response to the actual attitude of the load being between the preset attitude of the load and the desired attitude of the load, control the stabilization assembly to rotate at a first rotation speed;
in response to the preset attitude of the load being between the actual attitude of the load and the desired attitude of the load, control the stabilization assembly to rotate at a second rotation speed greater than the first rotation speed.

11. The handheld gimbal of claim 6, wherein:
the inertial measurement unit is further configured to obtain a current motion state of the load; and
the microcontroller is further configured to control the rotation of the stabilization assembly according to the operation mode of the handheld gimbal, the actual attitude of the load, the actual attitude of the handle, the preset attitude of the load, and the current motion state of the load.

12. A control method of a handheld gimbal comprising:
determining an operation mode of a handheld gimbal, the handheld gimbal including a handle and a stabilization assembly mounted at the handle, and the stabilization assembly being configured to carry a load;
obtaining an actual attitude of the load and an actual attitude of the handle; and
controlling rotation of the stabilization assembly according to the operation mode of the handheld gimbal, the actual attitude of the load, and the actual attitude of the handle, to cause the load to rotate to a desired attitude.

13. The method of claim 12, wherein determining the operation mode of the handheld gimbal includes at least one of:
obtaining a control operation of a user to set the handheld gimbal 100 to the operation mode;
determining that a mode detection device is in a preset condition; or
obtaining an operation of mounting the handheld gimbal to an accessory.

14. The method of claim 13, wherein the mode detection device includes at least one of a detection structure, a detection reagent or a detection sensor.

15. The method of claim 13, wherein the accessory includes a waterproof case.

16. The method of claim 12, wherein the desired attitude of the load is determined by the operation mode.

17. The method of claim 12, further comprising:
obtaining a preset attitude of the load;
wherein controlling the rotation of the stabilization assembly includes:
controlling the rotation of the stabilization assembly according to the operation mode of the handheld gimbal, the actual attitude of the load, the actual attitude of the handle and the preset attitude of the load.

18. The method of claim 17, wherein obtaining the preset attitude of the load includes:
determining the preset attitude according to the operation mode.

19. The method of claim 17, wherein obtaining the preset attitude of the load includes:
obtaining a set attitude input by a user; and
determining the set attitude as the preset attitude of the load.

20. The method of claim 17, wherein:
obtaining the actual attitude of the load includes obtaining an actual rotation angle of the load relative to the handle; and
obtaining the preset attitude of the load includes obtaining a preset rotation angle of the load relative to the handle.
